(19) United States
(12) Patent Application Publication
(10) Pub. No.: US 2025/0333218 A1
(43) Pub. Date: Oct. 30, 2025

(54) STORAGE CONTAINER

(71) Applicant: KREATE BRANDS LLC, Findlay, OH (US)

(72) Inventors: NICKOLAS REINHART, Sarasota, FL (US); JOE KLEIN, Findlay, OH (US); BEN SAYALITH, Findlay, OH (US)

(21) Appl. No.: 19/261,384

(22) Filed: Jul. 7, 2025

Related U.S. Application Data
(63) Continuation-in-part of application No. 29/935,060, filed on Mar. 29, 2024.
(63) Continuation-in-part of application No. 29/935,048, filed on Mar. 29, 2024.
(63) Continuation-in-part of application No. 29/935,053, filed on Mar. 29, 2024.
(63) Continuation-in-part of application No. 29/935,033, filed on Mar. 29, 2024.
(63) Continuation-in-part of application No. 29/935,044, filed on Mar. 29, 2024.
(63) Continuation-in-part of application No. 29/935,040, filed on Mar. 29, 2024.
(63) Continuation-in-part of application No. 29/935,038, filed on Mar. 29, 2024.
(63) Continuation-in-part of application No. 29/935,037, filed on Mar. 29, 2024.
(63) Continuation-in-part of application No. 29/935,035, filed on Mar. 29, 2024.
(63) Continuation-in-part of application No. 29/935,034, filed on Mar. 29, 2024, now Pat. No. D1085726.
(60) Provisional application No. 63/667,972, filed on Jul. 5, 2024.

(51) Int. Cl. B65D 50/00; B65D 1/26; B65D 43/02; B65D 43/06; B65D 51/24; B65D 81/26

(52) U.S. Cl. CPC B65D 50/00; B65D 1/26; B65D 43/0202; B65D 43/065; B65D 51/245; B65D 81/261; B65D 2203/02; B65D 2255/00; B65D 2543/00194; B65D 2543/0049; B65D 2543/00537; B65D 2543/00555

(57) ABSTRACT

Implementations claimed and described herein provide a storage container. The storage container comprising a body including a plurality of sidewalls, a body lip surrounding a periphery of the plurality of sidewalls, and a body lip aperture formed in the body lip. The storage container further comprises a lid configured to cover an opening into an interior of the body. The lid including a lid surface, a lid lip surrounding a periphery of the lid surface, and a lid lip aperture formed in the lid lip. The lid lip aperture and the body lip aperture are configured to receive a locking device. The lid lip aperture is smaller than the body lip aperture.

### CROSS-REFERENCE TO RELATED APPLICATIONS

The present application claims priority to U.S. Provisional Patent Application No. 63/667,972 filed on Jul. 5, 2024, and entitled “Storage Container” and is a continuation-in-part of U.S. application Ser. No. 29/935,060 filed Mar. 29, 2024, and entitled “Lid”, U.S. application Ser. No. 29/935,048 filed Mach 29, 2024, and entitled “Lid”, U.S. application Ser. No. 29/935,053 filed Mar. 29, 2024, and entitled “Container Base”, U.S. application Ser. No. 29/935,033 filed Mar. 29, 2024, and entitled “Container”, U.S. application Ser. No. 29/935,044 filed Mar. 29, 2024, and entitled “Lid”, U.S. application Ser. No. 29/935,040 filed Mar. 29, 2024, and entitled “Container Base”, U.S. application Ser. No. 29/935,038 filed Mar. 29, 2024, and entitled “Lid”, U.S. application Ser. No. 29/935,037 filed Mar. 29, 2024, and entitled “Container Base”, U.S. application Ser. No. 29/935,035 Mar. 29, 2024, and entitled “Lid”, and U.S. application Ser. No. 29/935,034 filed Mar. 29, 2024, and entitled “Lid”. Each of these applications are incorporated by reference in their entirety herein.

### FIELD

Aspects of the presently disclosed technology relate generally to storage containers and more particularly to a storage container with a water pass through feature.

### BACKGROUND

Storage containers are commonly used to house objects such as tools, recreational equipment, clothing, supplies, materials, and the like within a storage container body. A lid covers an open end of the body to contain and protect the objects disposed within the storage container. Often, it is desirable to restrict unauthorized access and/or accidental removal of the lid from the body. Cords, straps, or other devices may be used to further secure the lid to the body. However, these devices for securing the lid to the body may shift, become misaligned, and/or loose over time. This undesirably permits the lid to become unsecured from the lid and exposes the contents of the storage container to damage and/or theft. It is with these observations in mind, among others, that various aspects of the present disclosure were conceived and developed.

### SUMMARY

Implementations described and claimed herein address the foregoing problems by providing a storage container with a lid that facilitates a securing of the lid to a body the container. The lid includes water pass through features that restrict passage of water or other liquids from entering the body and possibly damaging contents being stored therein.

In some implementations, a storage container can comprise: a body and a lid. The body includes a plurality of sidewalls, a body lip surrounding a periphery of the plurality of sidewalls, and a body lip aperture formed in the body lip. The lid is configured to cover an opening into an interior of the body. The lid includes a lid surface, a lid lip surrounding a periphery of the lid surface, and a lid lip aperture formed in the lid lip. The lid lip aperture and the body lip aperture are configured to receive a locking device. The lid lip aperture is smaller than the body lip aperture.

In some implementations, a body of a storage container can comprise: a first sidewall, a second sidewall, a third sidewall, and a fourth sidewall forming an interior, a body lip surrounding a periphery formed by the first sidewall, the second sidewall, the third sidewall, and the fourth sidewall, and a body lip aperture formed in the body lip. The body lip aperture is configured to receive a locking device and is larger than a lid lip aperture formed in a lid configured to cover an opening into the interior.

In some implementations, a lid configured to cover an opening into an interior of a storage container can comprise: a lid surface, a lid lip surrounding a periphery of the lid surface, and a lid lip aperture formed in the lid lip and configured to receive a locking device. The lid lip aperture is smaller than a body lip aperture formed in a body forming the interior of the storage container.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates a perspective view of an example storage container.

FIG. 2 illustrates a top view of the example storage container of FIG. 1.

FIG. 3 illustrates a bottom view of the example storage container of FIG. 1.

FIG. 4 illustrates a perspective cross-sectional view of an example lid of the storage container of FIG. 1.

FIG. 5 illustrates a detailed top view of an example lid slot of a storage container.

FIG. 6 illustrates a detailed perspective view of an example body slot of a storage container.

FIG. 7 illustrates a front perspective view of another example storage container.

FIG. 8 illustrates a back perspective view of the example storage container of FIG. 7.

FIGS. 9-16 illustrate example storage containers having various sizes.

FIG. 17 illustrates a perspective view of another example storage container.

FIG. 18 illustrates a perspective view of the example storage container of FIG. 17 in an open state.

FIG. 19 illustrates a perspective view of another example storage container.

FIG. 20 illustrates a side view of the example storage container of FIG. 19.

FIG. 21 illustrates a front view of the example storage container of FIG. 19.

FIG. 22 illustrates a top view of the example storage container of FIG. 19.

FIG. 23 illustrates a bottom view of the example storage container of FIG. 19.

FIG. 24 illustrates a perspective view of another example storage container.

FIG. 25 illustrates a side view of the example storage container of FIG. 24.

FIG. 26 illustrates a front view of the example storage container of FIG. 24.

FIG. 27 illustrates a top view of the example storage container of FIG. 24.

FIG. 28 illustrates a bottom view of the example storage container of FIG. 24.

FIG. 29 illustrates a perspective view of another example storage container.

FIG. 30 illustrates a side view of the example storage container of FIG. 29.

FIG. 31 illustrates a front view of the example storage container of FIG. 29.

FIG. 32 illustrates a top view of the example storage container of FIG. 29.

FIG. 33 illustrates a bottom view of the example storage container of FIG. 29.

FIG. 34 illustrates a perspective view of another example storage container.

FIG. 35 illustrates a right side view of the example storage container of FIG. 34.

FIG. 36 illustrates a left side view of the example storage container of FIG. 34.

FIG. 37 illustrates a front view of the example storage container of FIG. 34.

FIG. 38 illustrates a top view of the example storage container of FIG. 34.

FIG. 39 illustrates a bottom view of the example storage container of FIG. 34.

FIG. 40 illustrates a perspective view of another example storage container.

FIG. 41 illustrates a left side view of the example storage container of FIG. 40.

FIG. 42 illustrates a right side view of the example storage container of FIG. 40.

FIG. 43 illustrates a front view of the example storage container of FIG. 40.

FIG. 44 illustrates a top view of the example storage container of FIG. 40.

FIG. 45 illustrates a bottom view of the example storage container of FIG. 40.

### DETAILED DESCRIPTION

Aspects of the present disclosure involve a storage container with a lid configured to be secured to a body using a locking device. The storage container includes a lock aperture that functions as a water pass through feature that restricts water or other liquids from infiltrating the body and possibly damaging contents being stored therein. Additional advantages of the presently disclosed technology will become apparent from the detailed description below.

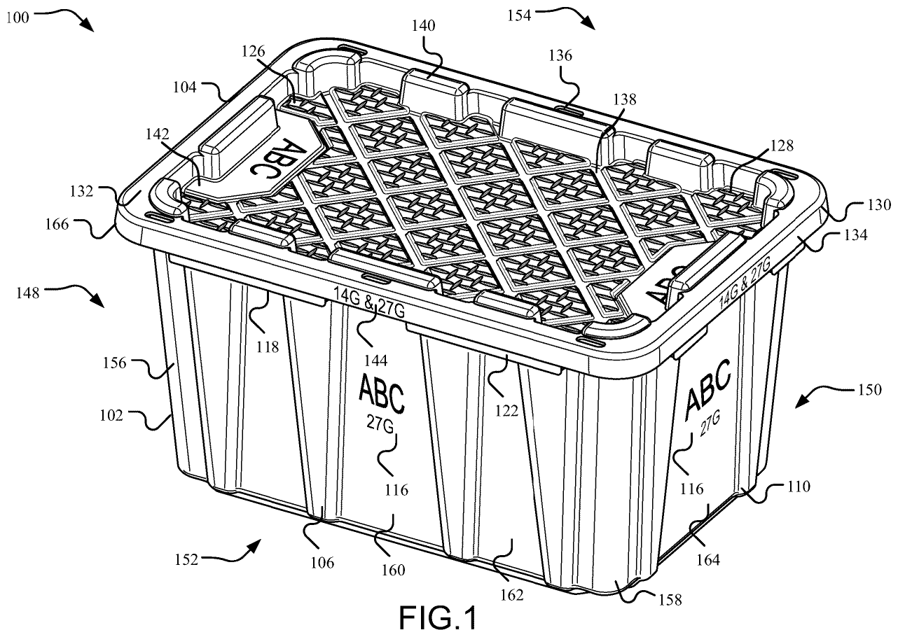

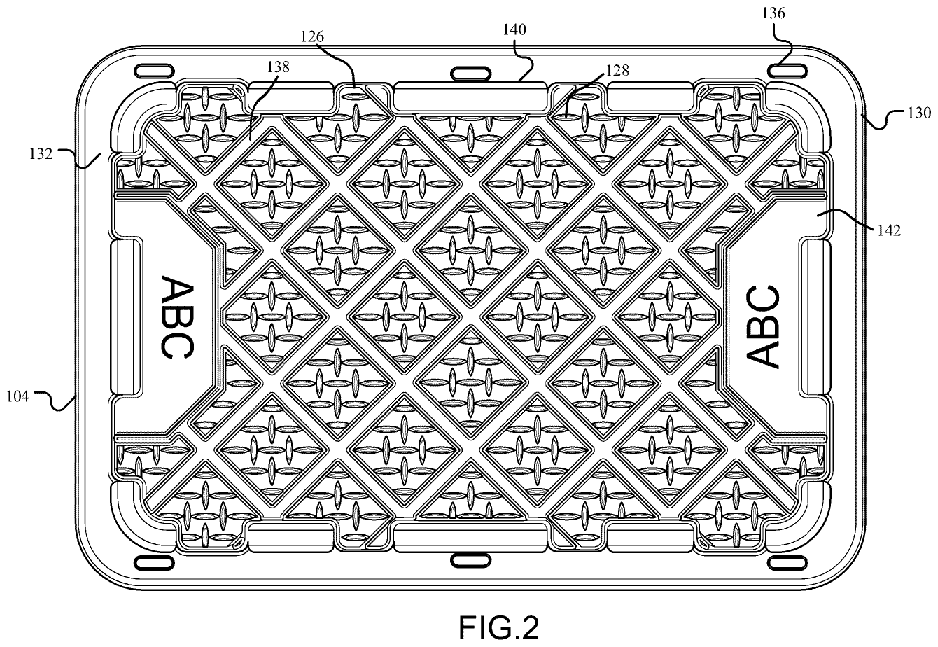

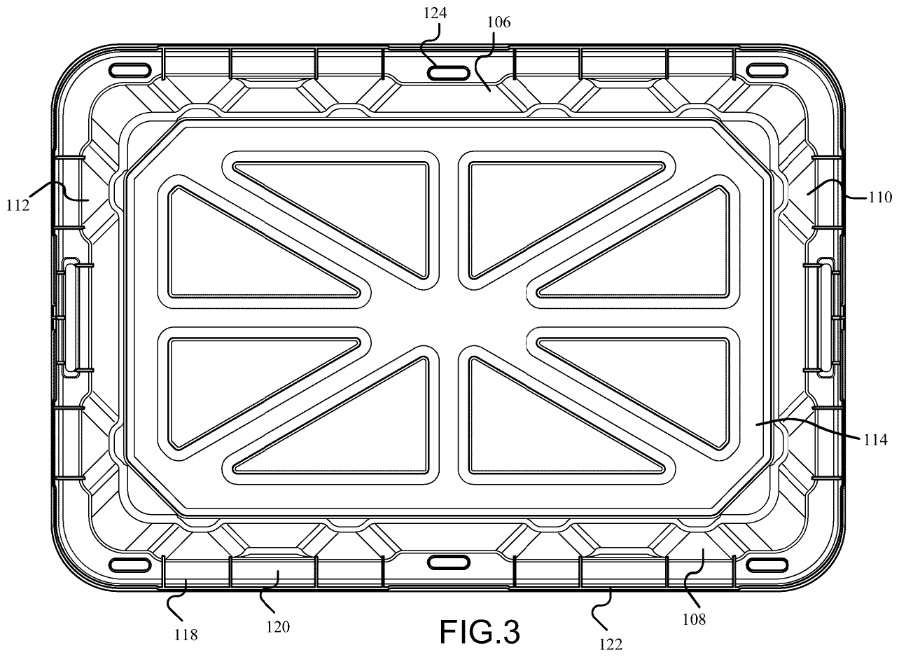

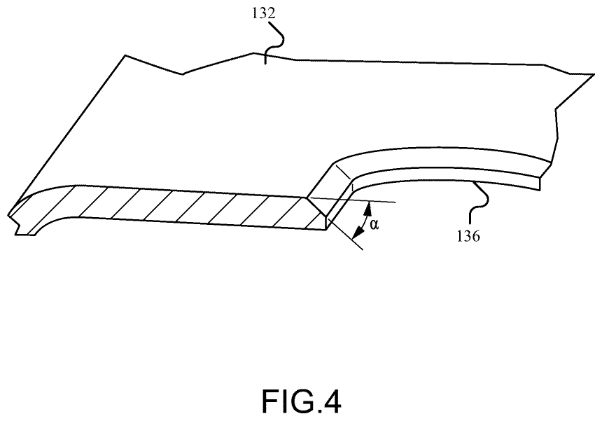

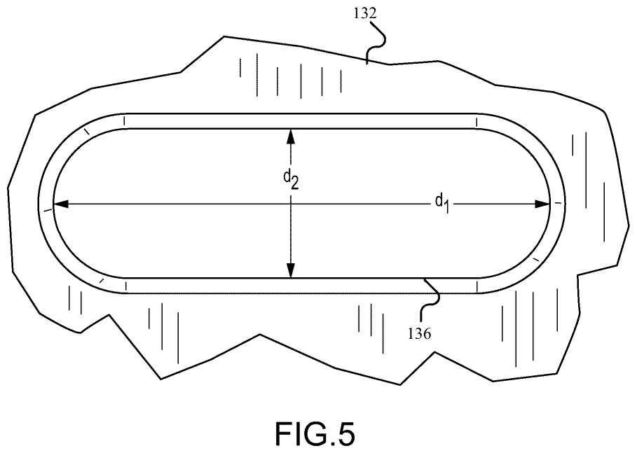

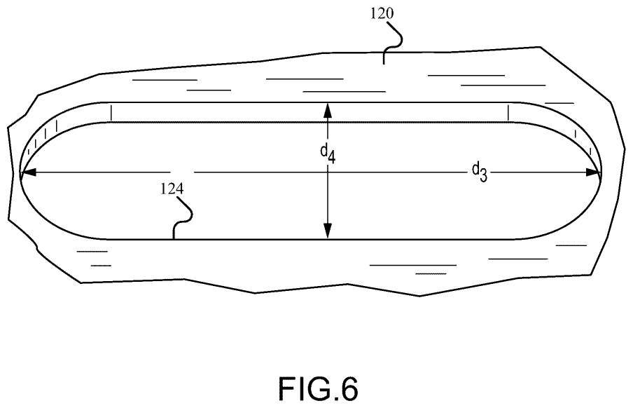

To begin, a detailed description of an example storage container 100, reference is made to FIGS. 1-6. In one implementation, the storage container 100 includes a body 102 and a lid 104 configured to cover an opening into an interior of the body 102. In an implementation, the lid 104 and the body 102 are composed of a polymeric material, such as, for example, plastic, via a manufacturing process, such as, for example, an injection molding process. In other implementations, the lid 104 and the body 102 are formed using other materials, such as a metal or a composite, and by other manufacturing processes, such as, for example, blow molding. In an implementation, the storage container 100 has a capacity of approximately 27 gallons.

In one implementation, the body 102 includes a first sidewall 106, a second sidewall 108, a third sidewall 110, and a fourth sidewall 112. In this implementation, the first sidewall 106 and the second sidewall 108 are opposing sidewalls oriented generally parallel to each other, and the third sidewall 110 and the fourth sidewall 112 are opposing sidewalls oriented generally parallel to each other. In an implementation, the first sidewall 106 and the second sidewall 108 are identical to each other, and the third sidewall 110 and the fourth sidewall 112 are identical to each other. In an implementation, the first sidewall 106 and the second sidewall 108 each extend between a first end 148 and a second end 150 and from a distal end 152 to a proximal end 154. In an implementation the first sidewall 106 and the second sidewall 108 are longer than the third sidewall 110 and the fourth sidewall 112 such that the body has a substantially rectangular shape. The body 102 further includes a bottom wall 114 coupled to the first sidewall 106, the second sidewall 108, the third sidewall 110, and the fourth sidewall 112. In other words, the bottom wall 114 connects distal ends of the first sidewall 106 and the second sidewall 108. The fourth sidewall 112 connects the first ends of the first sidewall 106 and the second sidewall 108, and the third sidewall 110 connects the second ends of the first sidewall 106 and the second sidewall 108. In one implementation, the first ends of the first sidewall 106 and the second sidewall 108 are connected with a contoured corner 156 of the fourth sidewall 112. In one implementation, the second ends of the first sidewall 106 and the second sidewall 108 are connected with a contoured corner 158 of the third sidewall 110. The bottom wall 114, the first sidewall 106, the second sidewall 108, the third sidewall 110, and the fourth sidewall 112 cooperatively define an interior of the body 102. In other implementations, the first sidewall 106, the second sidewall 108, the third sidewall 110, and the fourth sidewall 112 are equal, such that the body 102 has a substantially square shape. In an implementation, at least one of the first sidewall 106, the second sidewall 108, the third sidewall 110, or the fourth sidewall 112 can include body indication surfaces 116 with one or more indicators that indicate at least one of a logo or a capacity of the storage container 100. In an implementation, the one or more indicators are defined in the body indication surfaces 116 using engraving, printing, sticker, tag, graphics, etching, etc. In an implementation, various indents (e.g., 160, 162, and 164) may be formed on the body 102. In an implementation, the first sidewall 106 and the second sidewall 108 are identical, including the body indication surfaces 116, and the third sidewall 110 and the fourth sidewall 112 are identical, including the body indication surfaces 116.

In an implementation, the body 102 includes a body lip 118 surrounding a periphery formed by the first sidewall 106, the second sidewall 108, the third sidewall 110, and the fourth sidewall 112. The body lip 118 includes a first body lip surface 120 extending in a direction away from each of the first sidewall 106, the second sidewall 108, the third sidewall 110, and the fourth sidewall 112. In an implementation, the first body lip surface 120 is substantially parallel to the bottom wall 114. In an implementation, the body lip 118 includes a second body lip surface 122 that extends away from the first body lip surface 120 towards the bottom wall 114. In an implementation, the first body lip surface 120 and the second body lip surface 122 are disposed at an angle greater than 90 degrees, such as, for example, 95 degrees.

In an implementation, the body 102 includes at least one body lip aperture 124 formed in the first body lip surface 120. The body lip aperture 124 is configured to receive a locking device, such as, for example, a shank of a lock, a cable, a cable tie, etc. Although six body lip apertures 124 are illustrated, any suitable number may be used. In an implementation, the body lip aperture 124 is a slot having a body lip aperture slot length d₃ and a body lip aperture slot width d₄. In an implementation, the body lip aperture slot length d₃ is approximately 1½ inches, and the body lip aperture slot width d₄ is approximately ½ inch.

In an implementation, the lid 104 is completely removable from the body 102. The lid may be releasably coupled to the body 102 via one or more tabs. In this implementation, the one or more tabs engage the body lip 118 to releasably couple the lid 104 to the body 102. In an implementation, the lid 104 includes a lid surface 126. In an implementation, the lid surface 126 includes a plurality of surface features 128 to form a checker plate pattern or a diamond plate pattern. In an implementation, a lid lip 130 surrounding a periphery of the lid surface 126. The lid lip 130 includes a first lid lip surface 132 extending in a direction away from the lid surface 126. In an implementation, the first lid lip surface 132 is substantially parallel to the lid surface 126. In an implementation, the lid lip 130 includes a second lid lip surface 134 that extends away from the first lid lip surface 132 towards the lid surface 126. In an implementation, the first lid lip surface 132 and the second lid lip surface 134 are disposed at an angle greater than 90 degrees, such as, for example, 95 degrees.

In an implementation, one or more corners 166 of the lid 104 are curved, such that the second lid lip surface 134 has curvature in the area proximate to the corners.

In an implementation, the lid 104 includes at least one lid lip aperture 136 formed in the first lid lip surface 132. The lid lip aperture 136 is configured to align with the body lip aperture 124 when the lid 104 is coupled to the body 102. The lid lip aperture 136 is configured to receive a locking device, such as, for example, a shank of a lock, a cable, a cable tie, etc. Although six lid lip apertures 136 are illustrated, any suitable number may be used. In an implementation, the lid lip aperture 136 is a slot having a lid lip aperture slot length d₁ and a lid lip aperture slot width d₂. The lid lip aperture slot length d₁ is less than body lip aperture slot length d₃, such as, for example, approximately 1.356 inches, and lid lip aperture slot width d₂ is less than body lip aperture slot width d₄, such as, for example, approximately 0.406 inches. In other words, the lid lip aperture 136 is smaller than the body lip aperture 124 to restrict liquid, such as water from precipitation, from entering into the interior of the body 102. In an implementation, the lid lip aperture 136 is chamfered at angle α, such as, for example 45 degrees.

In an implementation, the lid 104 includes a plurality of grooves formed in the lid surface 126. In another implementation, the lid 104 includes a plurality of protrusions 140 disposed adjacent the lid lip 130 and extending from the lid surface 126. As illustrated, the plurality of protrusions 140 can be varying lengths and disposed at varying distances along the periphery of the lid surface 126. Although twelve protrusions 140 are illustrated, any suitable number of protrusions may be used. In an implementation, the plurality of protrusions 140 extend beyond the first lid lip surface 132. The plurality of protrusions 140 are configured to maintain an alignment of a cord, rope, cable, etc. across the lid 104 for securing the lid 104 to the body 102.

In an implementation, the lid surface 126 includes a first lid indication surface 142. The first lid indication surface 142 includes two portions disposed at opposing ends of the lid surface 126. At least one of a logo or a capacity of the storage container 100 can be defined in the first lid indication surface 142 using engraving, printing, sticker, tag, graphics, etching, etc.

In an implementation, the second lid lip surface 134 includes one or more second lid indication surfaces 144. In an implementation, the one or more second lid indication surfaces 144 include an indicator that indicates at least one of the logo or the capacity of the storage container 100. In an implementation, the indicator is defined in the one or more second lid indication surfaces 144 using engraving, printing, sticker, tag, graphics, etching, etc. In an implementation, the lid 104 includes four indicators (two are illustrated and the two not shown are located at identical positions as the two illustrated). However, the disclosure is not limited to four indicators and any suitable number of indicators may be used.

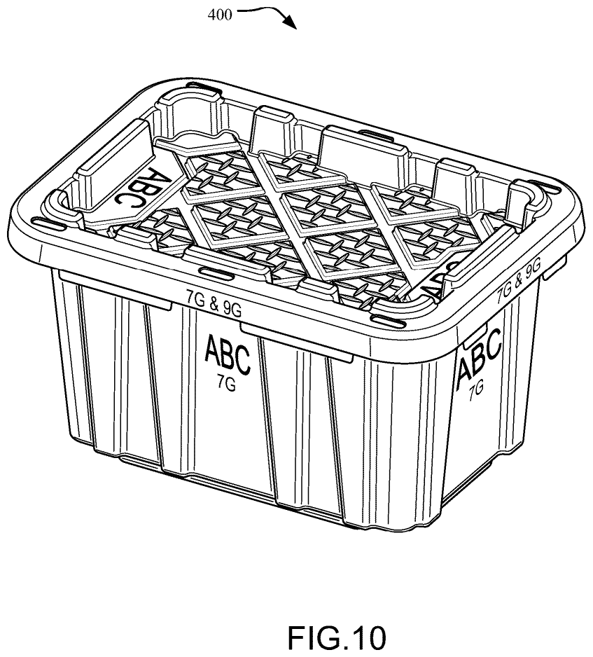

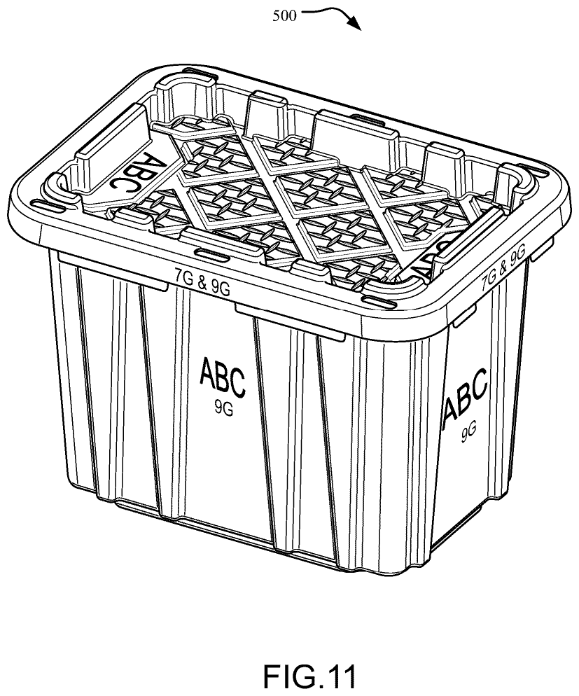

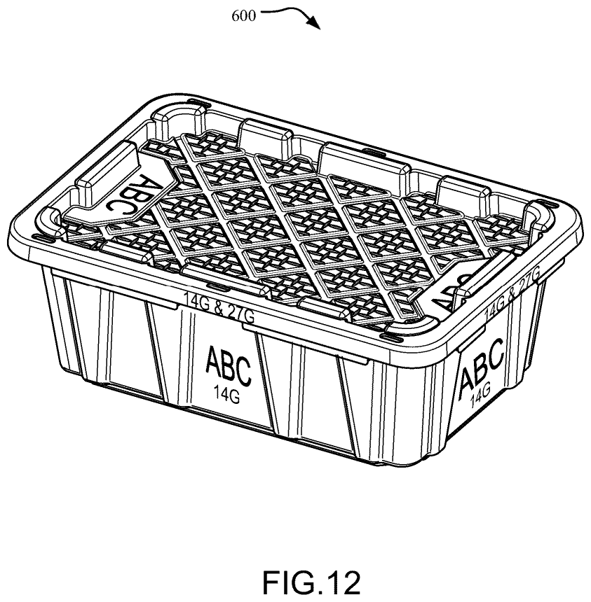

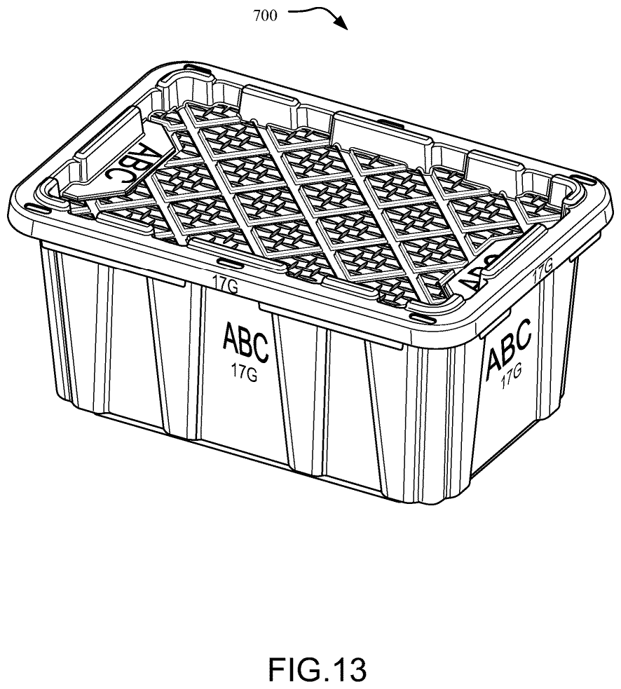

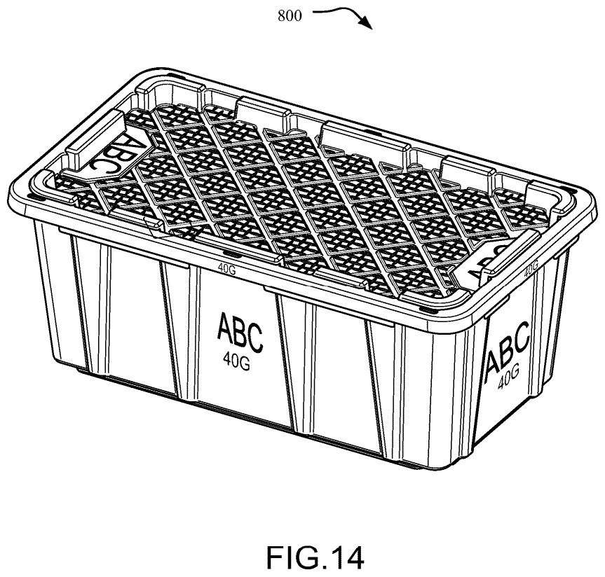

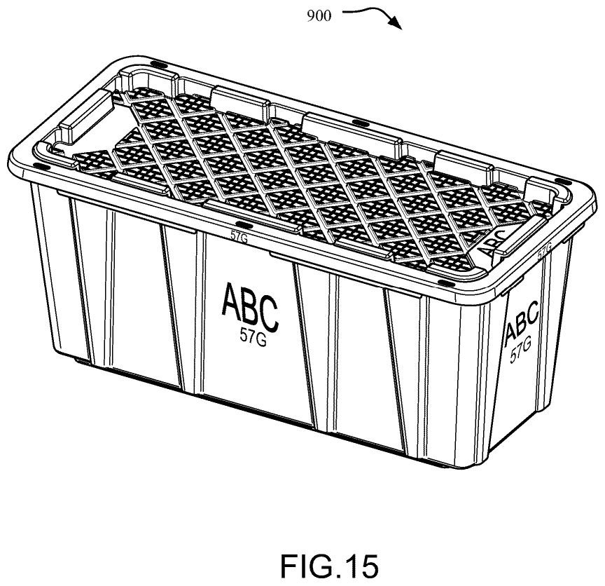

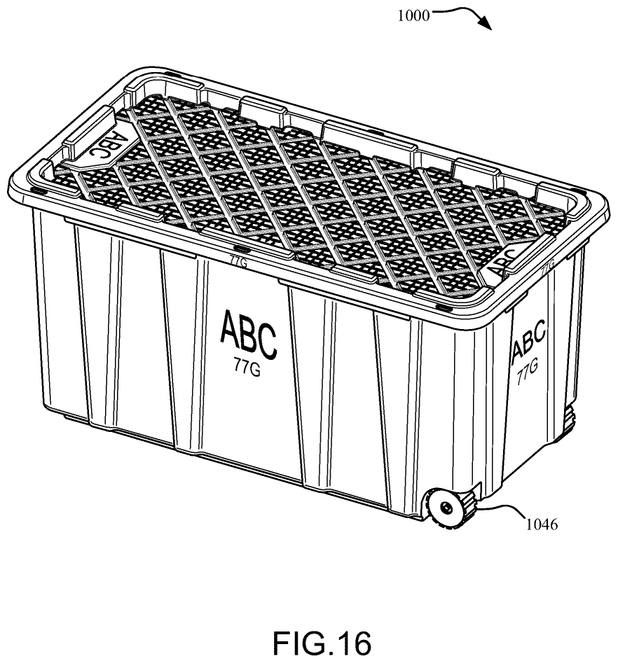

Turning to FIGS. 10-16, storage containers 400-1000 are illustrated. Storage containers 400-1000 are substantially similar to the storage container 100, except for capacity of the containers. Accordingly the indicator surfaces are in similar locations as described above (including two that are not shown), except the indicators are updated to reflect the capacity of the storage containers 400-1000. For instance, storage container 400 has a capacity of approximately 7 gallons and has indicators of ‘7 G’, storage container 500 has a capacity of approximately 9 gallons and has indicators of ‘9 G’, storage container 600 has a capacity of approximately 14 gallons and has indicators of ‘14 G’, storage container 700 has a capacity of approximately 17 gallons and has indicators of ‘17 G’, storage container 800 has a capacity of approximately 40 gallons and has indicators of ‘40 G’, storage container 900 has a capacity of approximately 57 gallons and has indicators of ‘57 G’, and storage container 1000 has a capacity of approximately 77 gallons and has indicators of ‘77 G’. In an implementation, the storage container 1000 includes one or more wheels 1046.

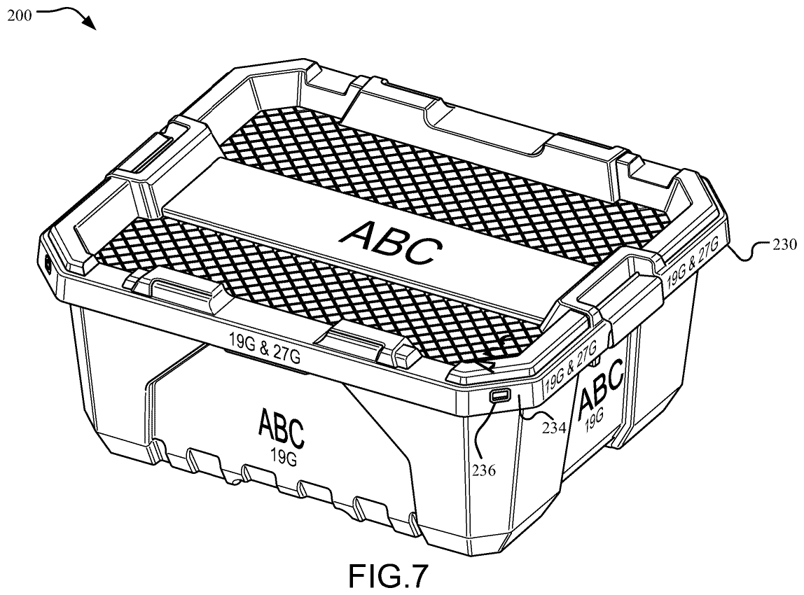

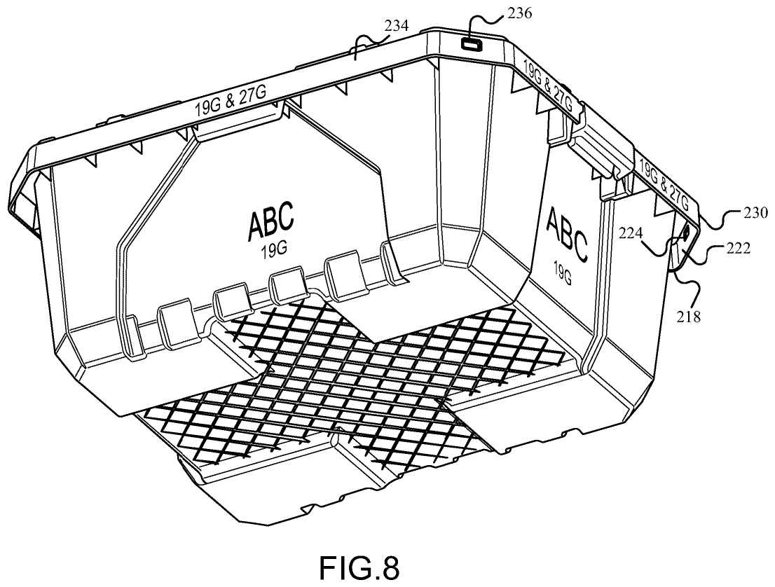

Turning to FIGS. 7-8, in one implementation, a storage container 200 is illustrated. The storage container 200 is substantially similar to the storage container 100, except a body lip aperture 224 is formed in a second body lip surface 222 of a body lip 218, and a lid lip aperture 236 is formed in a second lid lip surface 234 of a lid lip 230. In an implementation, a capacity of the storage container 200 is approximately 19 gallons and includes indicators as discussed above with respect to storage container 100.

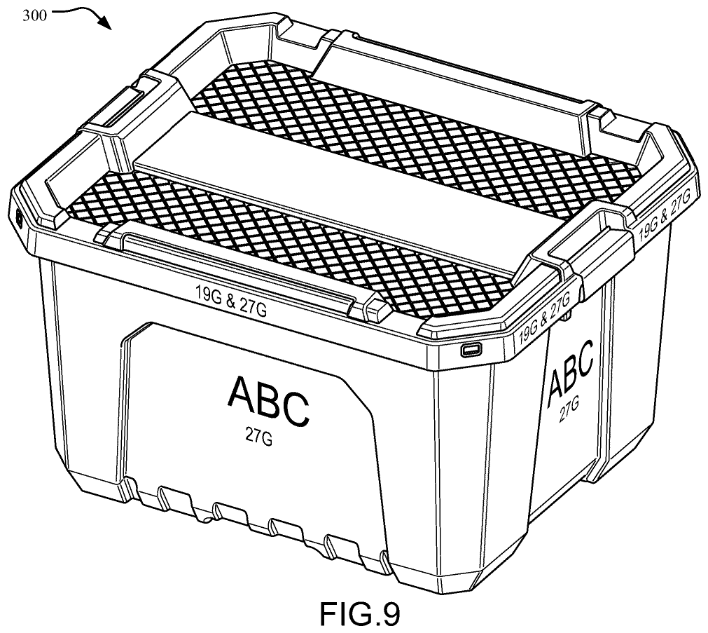

Turning to FIG. 9, in one implementation a storage container 300 is illustrated. The storage container 300 is substantially similar to the storage container 200, except a capacity of the storage container 300 is approximately 27 gallons.

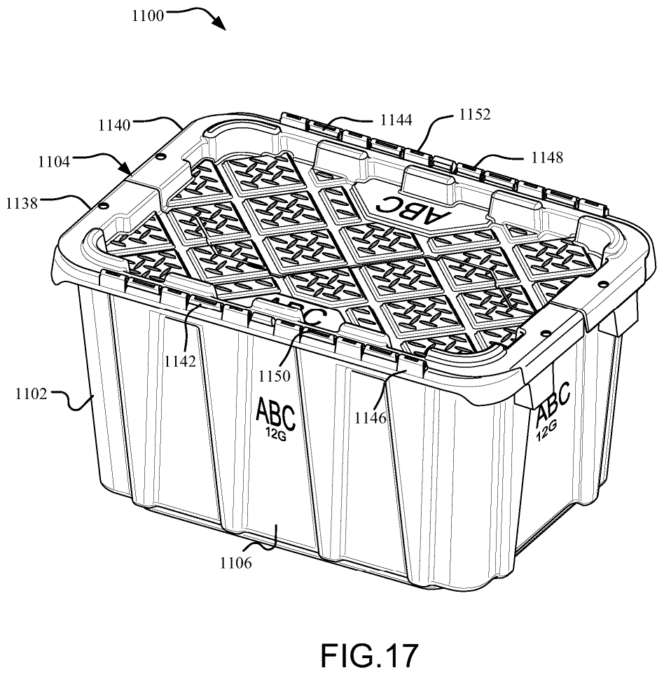

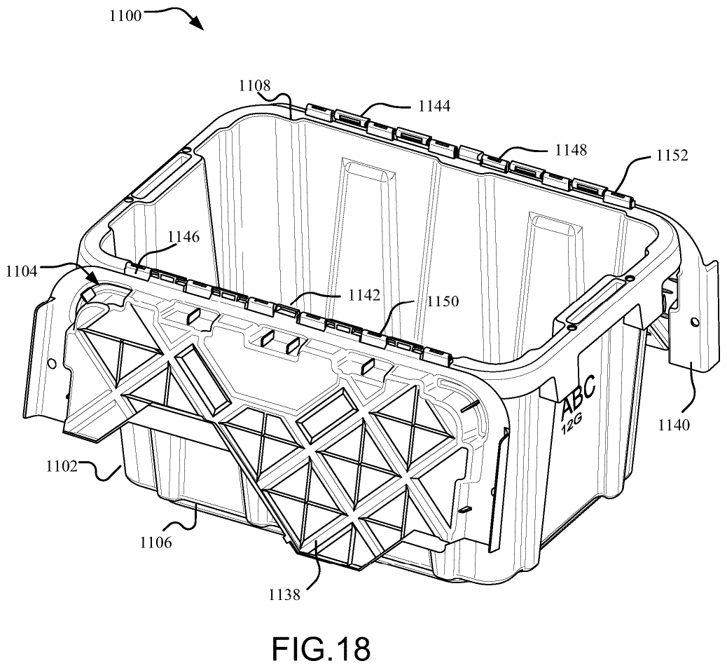

Turning to FIGS. 17 and 18, in one implementation, a storage container 1100 is illustrated. The storage container 1100 is substantially similar to the storage container 100, including the indicators on the body 1102, except the lid 1104 is rotatably coupled to the body 1102. In an implementation, the lid 1104 includes a first lid half 1138 and a second lid half 1140. In this implementation, the first lid half 1138 includes a plurality of first lid receiving surfaces 1142, the second lid half 1140 includes a plurality of second lid receiving surfaces 1144, and the body 1102 includes a plurality of first body receiving surfaces 1146 disposed along the first sidewall 1106 and a plurality of second boy receiving surfaces 1148 disposed along the second sidewall 1108. In an implementation, a first hinge 1150 is disposed within the plurality of first lid receiving surfaces 1142 and the plurality of first body receiving surfaces 1146 to rotably couple the first lid half 1138 to the body 1102 to allow the first lid half 1138 to rotate between a closed position (illustrated in FIG. 17) and an open position (illustrated in FIG. 18). In an implementation, a second hinge 1152 is disposed within the plurality of second lid receiving surfaces 1144 and the plurality of first body receiving surfaces 1146 to rotably couple the second lid half 1140 to the body 1102 to allow the second lid half 1140 to rotate between a closed position (illustrated in FIG. 17) and an open position (illustrated in FIG. 18). In an implementation, each of the first hinge 1150 and the second hinge 1152 is a rod. Although the lid 1104 is illustrated with two halves and hinges, the disclosure is not limited as such. For instance, in an implementation (not shown), the lid 1104 is monolithic and is rotatably coupled to the body 1102 via a single hinge.

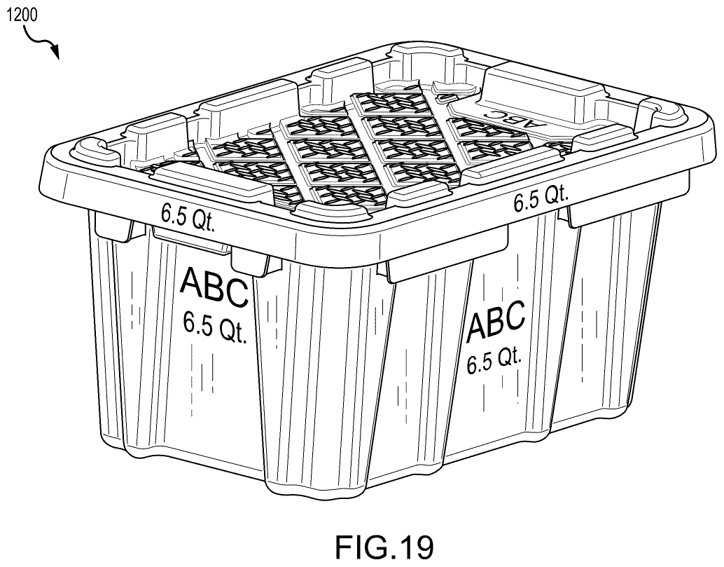

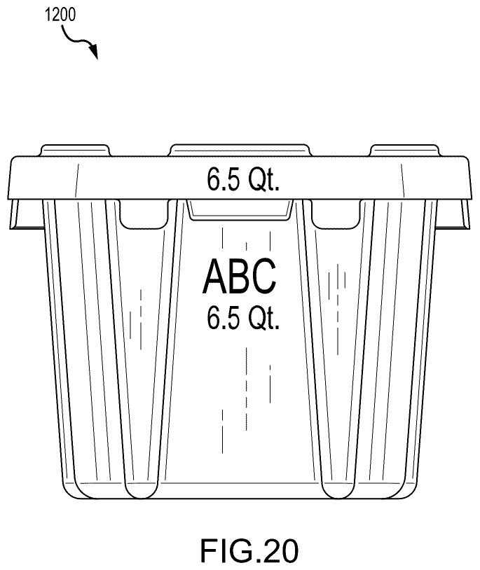

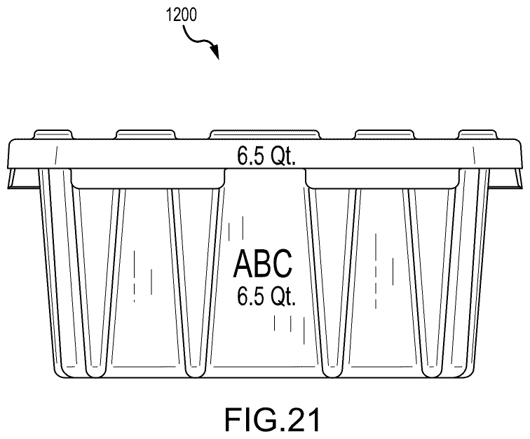

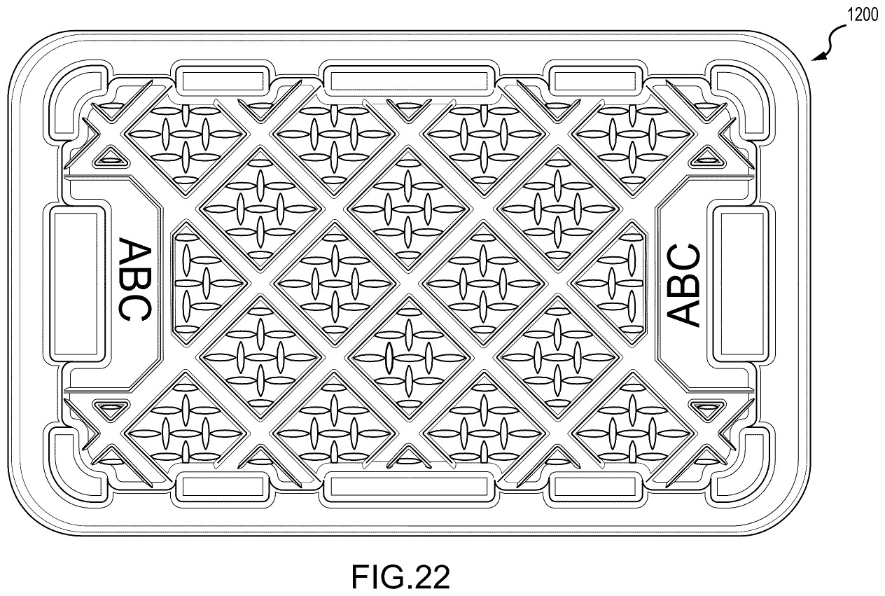

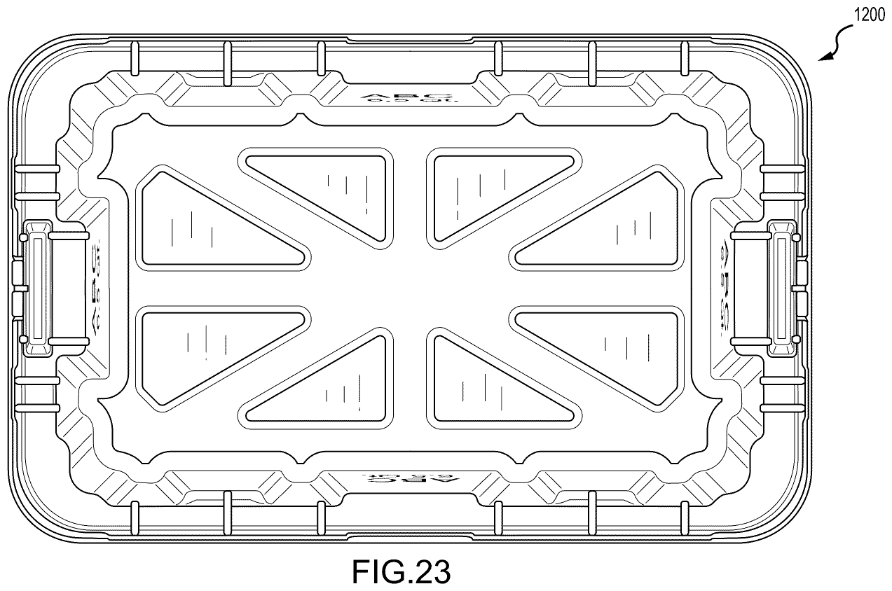

Turning to FIGS. 19-23, a storage container 1200 is illustrated according to an implementation. The storage container 1200 is substantially similar to the storage container 100, except for capacity of the container. Accordingly the indicators are in similar locations as described above, except the indicators are updated to reflect the capacity of the storage container 1200. For instance, the storage container 1200 has a capacity of approximately 6.5 quarts and has indicators of ‘6.5 Qt.’ In an implementation, the right side and left side of the storage container 1200 are the same, and the front side and the back side of the storage container 1200 are the same.

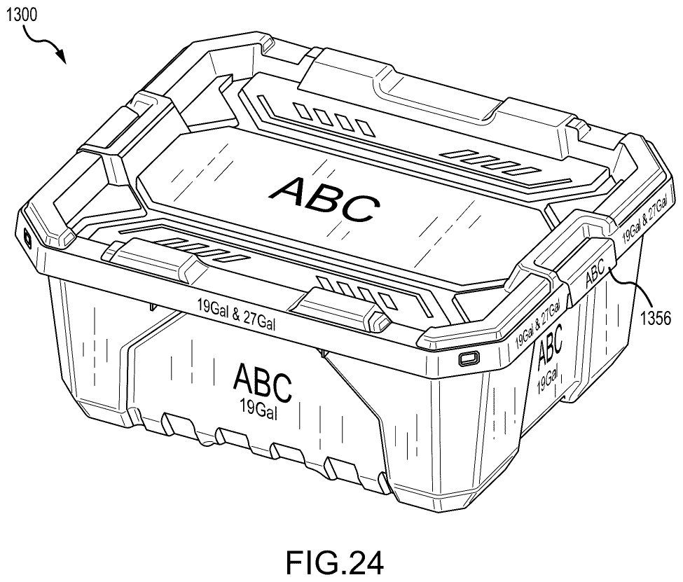

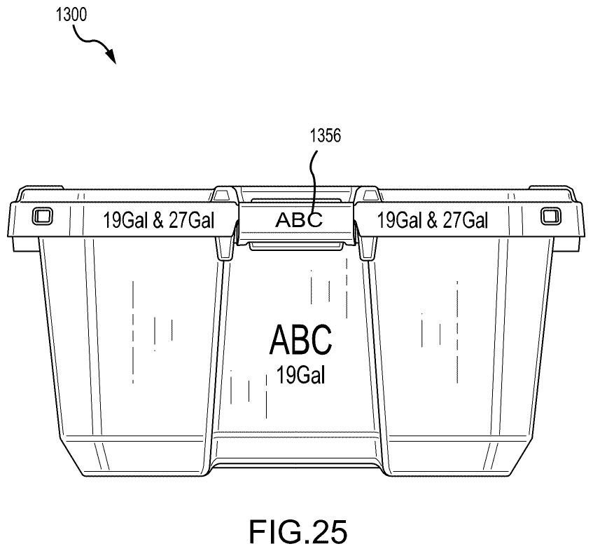

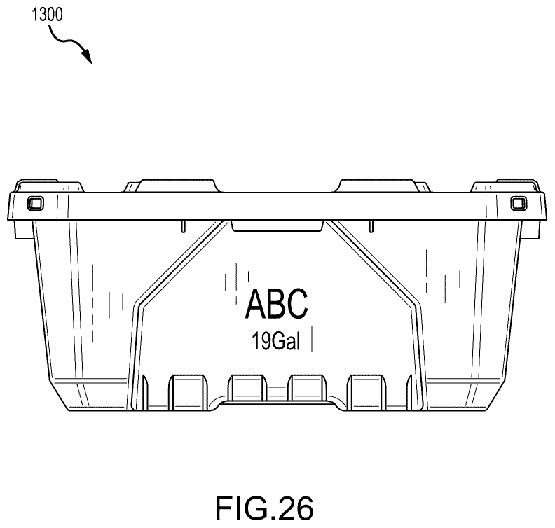

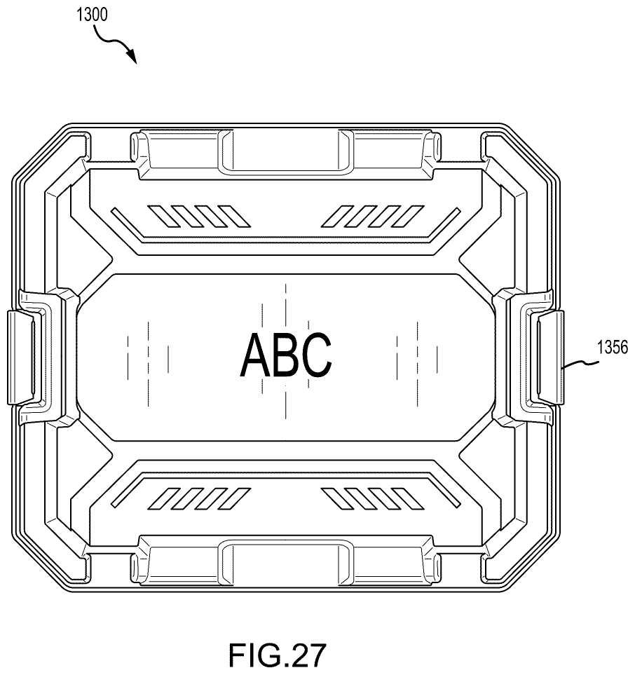

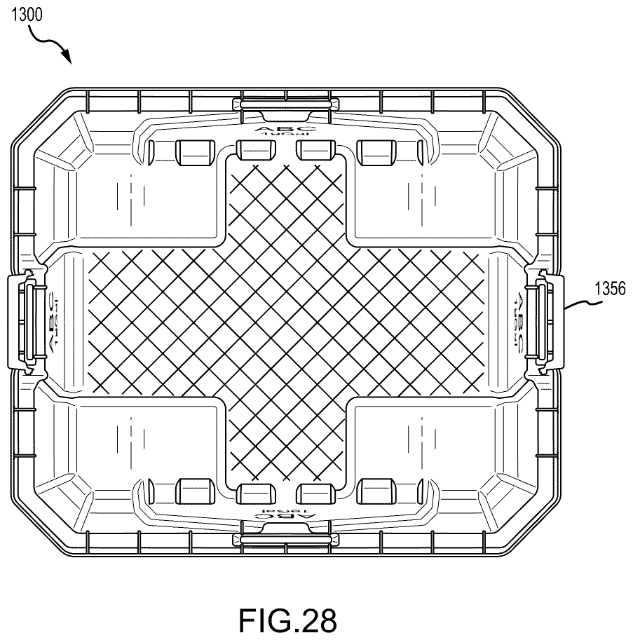

Turning to FIGS. 24-28, a storage container 1300 is illustrated according to an implementation. The storage container 1300 is substantially similar to the storage container 200, except the clip 1356 retaining the lid disposed at opposing ends of the storage container 1300 includes an indicator, such as a logo. The indicators are in similar locations as described above. For instance, the storage container 1300 has a capacity of approximately 19 gallons and has indicators of ‘19 Gal.’ In an implementation, the right side and left side of the storage container 1200 are the same, and the front side and the back side of the storage container 1300 are the same.

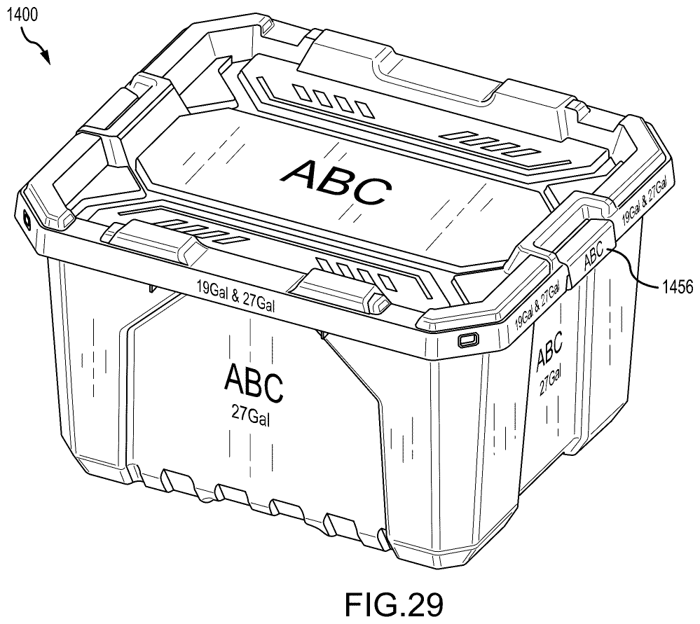

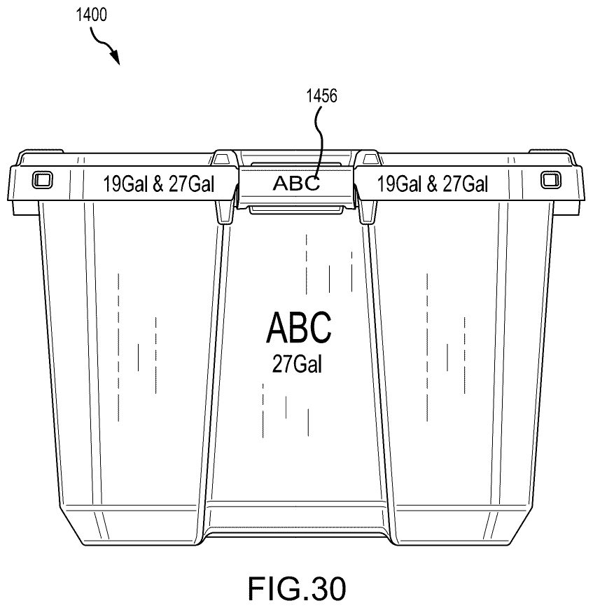

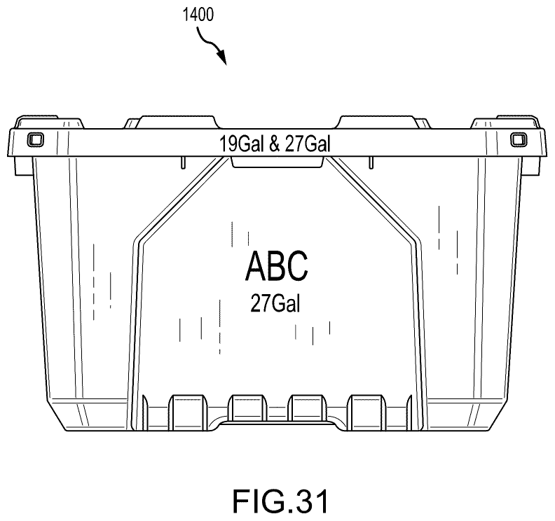

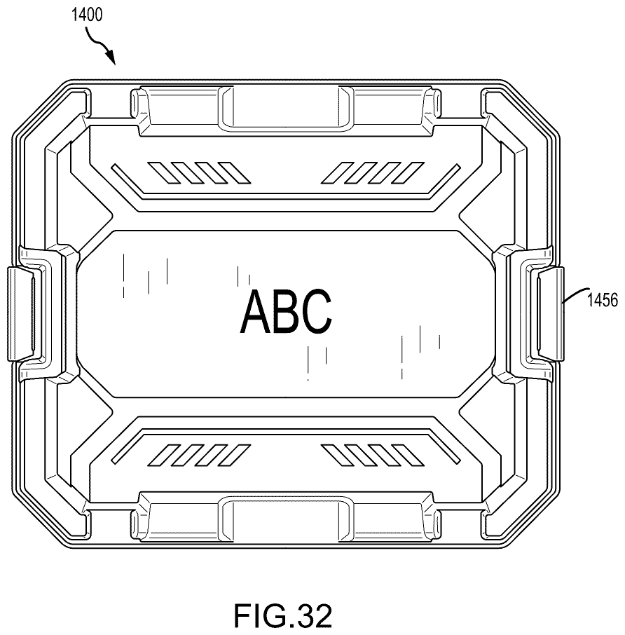

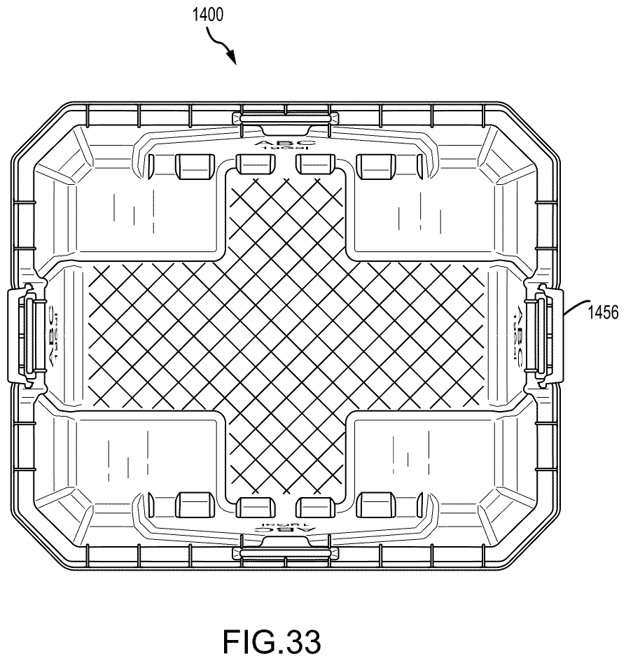

Turning to FIGS. 29-33, a storage container 1400 is illustrated according to an implementation. The storage container 1400 is substantially similar to the storage container 1300, except for capacity of the container. Accordingly the indicators are in similar locations as described above, except the indicators are updated to reflect the capacity of the storage container 1400. For instance, the storage container 1400 has a capacity of approximately 27 gallons and has indicators of ‘27 Gal.’ In an implementation, the right side and left side of the storage container 1400 are the same, and the front side and the back side of the storage container 1400 are the same.

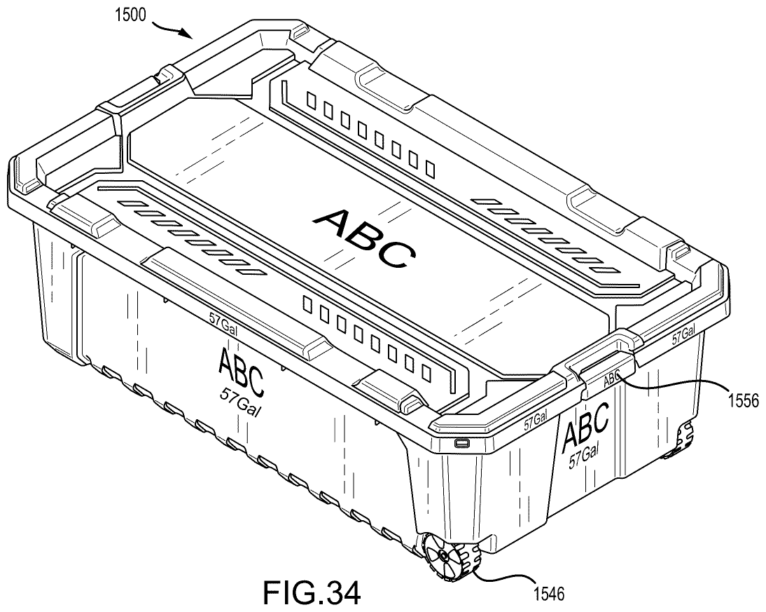

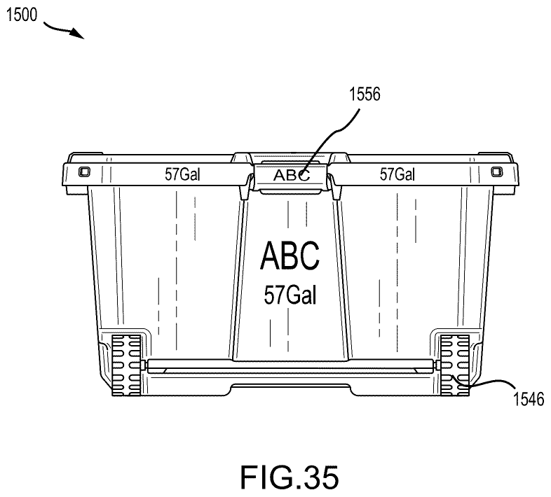

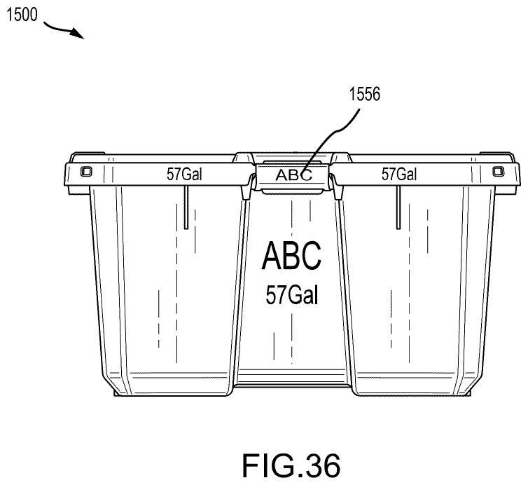

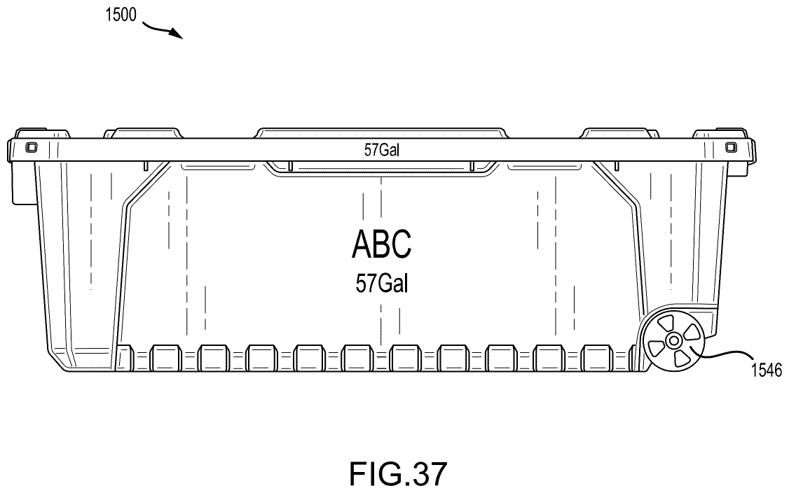

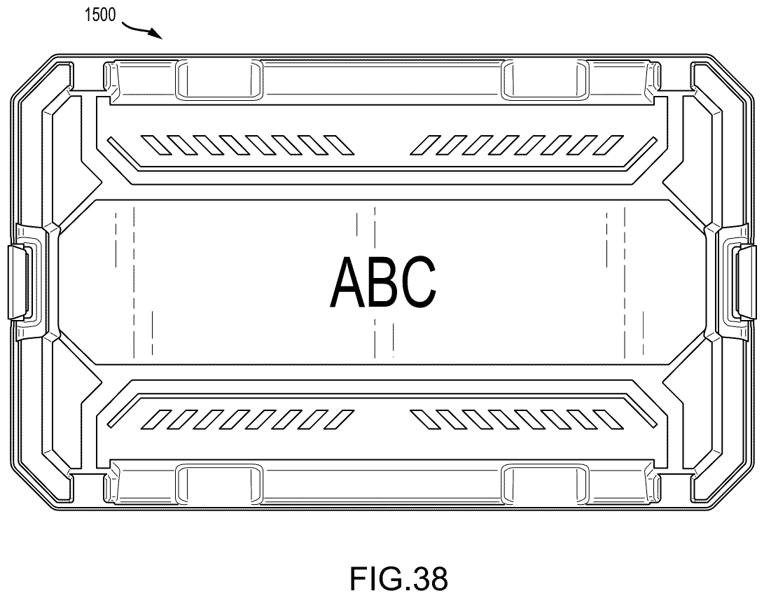

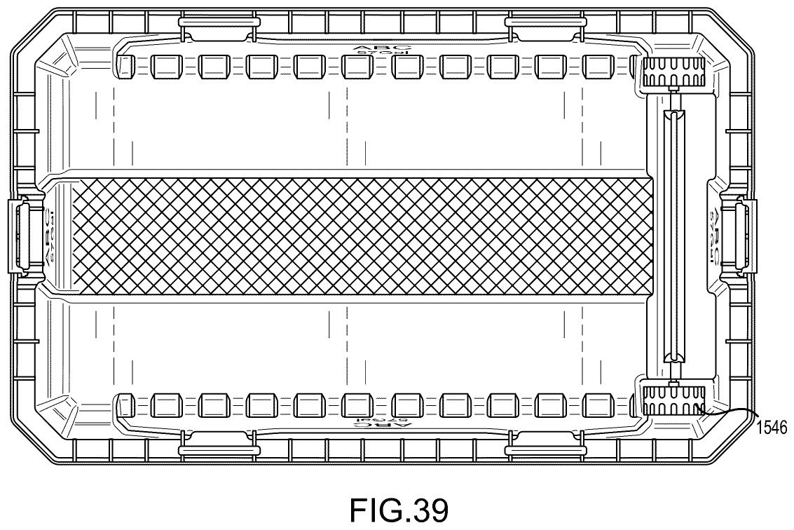

Turning to FIGS. 34-39, a storage container 1500 is illustrated according to an implementation. The storage container 1500 is substantially similar to the storage container 1300, except for capacity of the container and one or more wheels 1546. Accordingly the indicators are in similar locations as described above, except the indicators are updated to reflect the capacity of the storage container 1500. For instance, the storage container 1500 has a capacity of approximately 57 gallons and has indicators of ‘57 Gal.’ In an implementation, the front side, as illustrated in FIG. 37, is a mirror of the back side (not shown) of the storage container 1500.

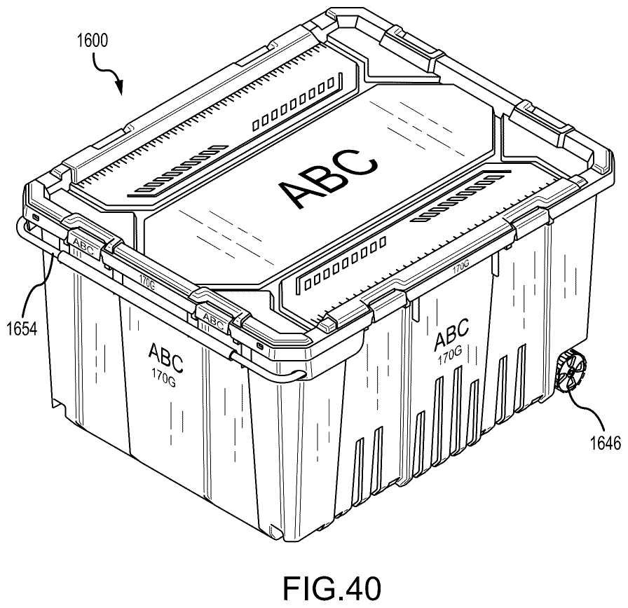

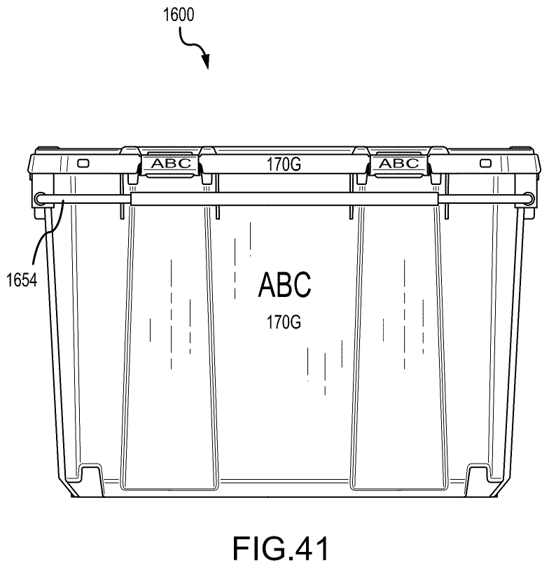

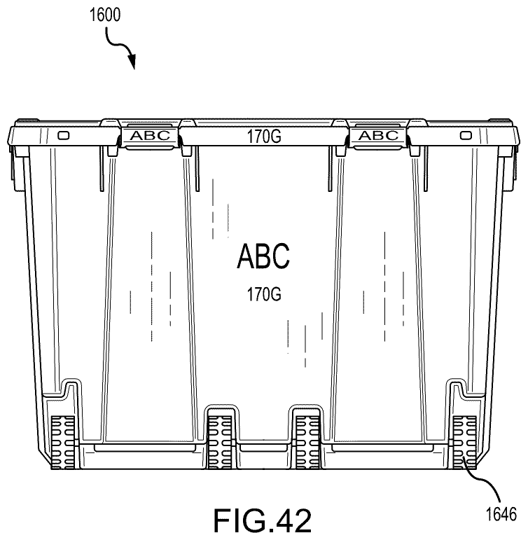

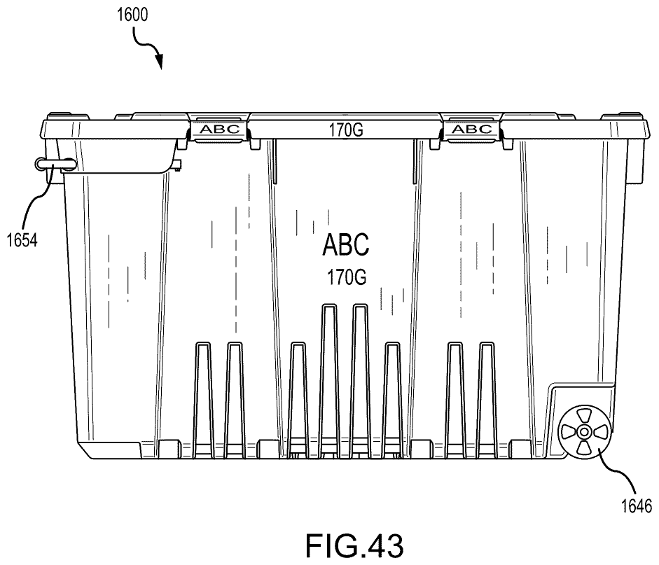

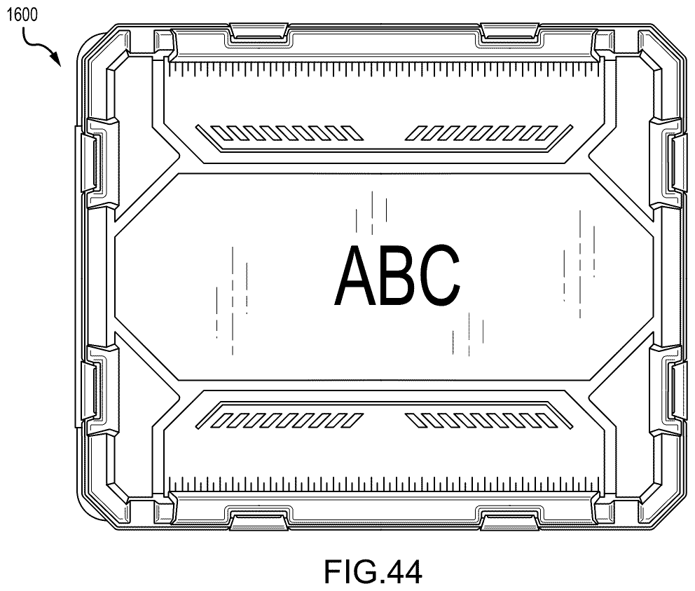

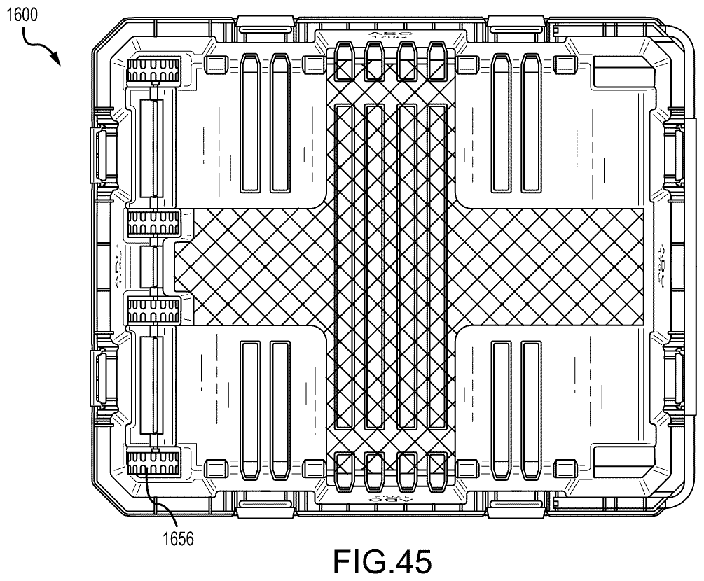

Turning to FIGS. 40-45, a storage container 1600 is illustrated according to an implementation. The storage container 1600 is substantially similar to the storage container 1300, except for capacity of the container and one or more wheels 1646 and a handle 1654. Accordingly the indicators are in similar locations as described above, except the indicators are updated to reflect the capacity of the storage container 1500. For instance, the storage container 1600 has a capacity of approximately 170 gallons and has indicators of ‘170 G.’ In an implementation, the front side, as illustrated in FIG. 43, is a mirror of the back side (not shown) of the storage container 1600.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A storage container comprising:
a body including:
a plurality of sidewalls;
a body lip surrounding a periphery of the plurality of sidewalls; and
a body lip aperture formed in the body lip; and
a lid configured to cover an opening into an interior of the body, the lid including:
a lid surface;
a lid lip surrounding a periphery of the lid surface; and
a lid lip aperture formed in the lid lip, the lid lip aperture and the body lip aperture configured to receive a locking device, the lid lip aperture smaller than the body lip aperture.

2. The storage container of claim 1, wherein the plurality of sidewalls include a first sidewall, a second sidewall, a third sidewall, and a fourth sidewall,
wherein the first sidewall and the second sidewall each extend between a first end and a second end and from a distal end to a proximal end, the fourth sidewall connecting the first end of the first sidewall and the first end of the second sidewall, the third sidewall connecting the second end of the first sidewall and the second end of the second sidewall.

3. The storage container of claim 2, wherein the first sidewall and the second sidewall are longer than the third sidewall and the fourth sidewall.

4. The storage container of claim 1, wherein the body lip includes a first body lip surface and a second body lip surface.

5. The storage container of claim 4, wherein the body lip aperture is formed in the first body lip surface.

6. The storage container of claim 1, wherein the lid lip includes a first lid lip surface and a second lid lip surface.

7. The storage container of claim 6, wherein the lid lip aperture is formed in the first lid lip surface.

8. The storage container of claim 1, wherein each of the plurality of sidewalls includes a body indication surface, and the lid includes one or more lid indication surfaces.

9. A body of a storage container, the body comprising:
a first sidewall, a second sidewall, a third sidewall, and a fourth sidewall forming an interior;
a body lip surrounding a periphery formed by the first sidewall, the second sidewall, the third sidewall, and the fourth sidewall; and
a body lip aperture formed in the body lip, the body lip aperture is configured to receive a locking device, the body lip aperture larger than a lid lip aperture formed in a lid configured to cover an opening into the interior.

10. The body of claim 9, wherein the first sidewall and the second sidewall each extend between a first end and a second end and from a distal end to a proximal end, the fourth sidewall connecting the first end of the first sidewall and the first end of the second sidewall, the third sidewall connecting the second end of the first sidewall and the second end of the second sidewall.

11. The body of claim 9, wherein the body lip includes a first body lip surface and a second body lip surface.

12. The body of claim 11, wherein the body lip aperture is formed in the first body lip surface or the second body lip surface.

13. The body of claim 9, wherein each of the first sidewall, the second sidewall, the third sidewall, and the fourth sidewall includes a body indication surface.

14. The body of claim 9, wherein the body lip aperture is a slot.

15. A lid configured to cover an opening into an interior of a storage container, the lid comprising:
a lid surface;
a lid lip surrounding a periphery of the lid surface; and
a lid lip aperture formed in the lid lip and configured to receive a locking device, the lid lip aperture smaller than a body lip aperture formed in a body forming the interior of the storage container.

16. The lid of claim 15, wherein the lid lip includes a first lid lip surface and a second lid lip surface.

17. The lid of claim 16, wherein the lid lip aperture is formed in the first lid lip surface.

18. The lid of claim 16, wherein the lid lip aperture is formed in the second lid lip surface.

19. The lid of claim 15, wherein the lid lip aperture is a slot.

20. The lid of claim 15, wherein the lid includes one or more lid indication surfaces.
